(19) United States
(12) Patent Application Publication
(10) Pub. No.: US 2014/0267870 A1
(43) Pub. Date: Sep. 18, 2014

(54) MIXED MEDIA FROM MULTIMODAL SENSORS

(71) Applicant: TANGOME, INC., Palo Alto, CA (US)

(72) Inventors: Xu Liu, San Jose, CA (US); Jamie Odell, Foster City, CA (US); Gary Chevsky, Palo Alto, CA (US)

(73) Assignee: TANGOME, INC., Palo Alto, CA (US)

(21) Appl. No.: 13/837,443

(22) Filed: Mar. 15, 2013

(51) Int. Cl. H04N 5/232

(52) U.S. Cl. CPC H04N 5/23293
USPC 348/333.05

(57) ABSTRACT

Methods and systems a mixed media communication from multimodal sensors are disclosed. A first data is captured at a first image capturing device associated with a first communication device. A second data is captured at a second image capturing device associated with the first communication device. The first data and the second data are simultaneously sent to a second communication device to be displayed simultaneously on a display of the second communication device.

### BACKGROUND

Modern technologies allow for various methods and techniques for communicating between two devices. Communications may occur over a network. The communications may be limited by the technology such that a user may not be able to send the type of message desired and may not have desired flexibility in combining different media in a communication.

### BRIEF DESCRIPTION OF THE DRAWINGS

FIG. 1 illustrates a block diagram of an example device for a mixed media communication from multimodal sensors in accordance with embodiments of the present technology.

FIG. 2 illustrates a block diagram of an example device for a mixed media communication from multimodal sensors in accordance with embodiments of the present technology.

FIG. 3A illustrates a block diagram of an example environment for a mixed media communication from multimodal sensors in accordance with embodiments of the present technology.

FIG. 3B illustrates a block diagram of an example device for a mixed media communication from multimodal sensors in accordance with embodiments of the present technology.

FIG. 4 illustrates a flowchart of an example method for a mixed media communication from multimodal sensors in accordance with embodiments of the present technology.

FIG. 5 illustrates a flowchart of an example method for a mixed media communication from multimodal sensors in accordance with embodiments of the present technology.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “capturing,” “receiving,” “sending,” “creating,” “filtering,” “swapping,” “communicating,” “displaying,” or the like, refer to the actions and processes of a computer system, or similar electronic computing device. The computer system or similar electronic computing device, such as a telephone, smartphone, or handheld mobile device, manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of a Mixed Media Communication from Multimodal Sensors

Embodiments of the present technology are for a mixed media communication from multimodal sensors. The communication may be between two devices such as a cell phones, smart phones, computers, laptops, televisions, hand held electronic devices, etc. The devices are capable of capturing or generating images, video, audio, text, animations, and other effects, or combinations thereof, as well as displaying or playing images, video, audio, text, animations, and other effects. The combination of images, video, audio, text, animations, and other effects may be described as mixed media. The devices may have multimodal sensors such as an image capturing device, camera, microphone, light sensor, etc. In one embodiment, the communication occurs over a network such as a cellular network, a wifi network, or other network used for communication.

The communication makes use of a combination of media available to a device. In one embodiment, the communication is a mixed media communication that comprises an image and a video and audio stream. The video and audio stream may or may not be related to the image. For example, a user of the device may take a picture of an object using a first camera associated with the device and a video and audio stream using a second camera and a microphone associated with the device. The image with the video and audio stream are simultaneously sent from the device that generated the mixed media to a second device. The second device then has a display that is capable of simultaneously displaying the image and the video stream as well as speaks for playing the audio. The display of the second device may automatically display the image and video stream upon receiving them.

In one embodiment, the device generating the mixed media also displays the image and video stream so that the user may be able to see what they are sending. In one embodiment, the image is related to the video stream. For example, a user may employ the device to capture an image and then employ the device to capture a video that features the user offering an explanation regarding the image. In one embodiment, the video and audio are captured and streamed in real time to the second device. In one embodiment, the video and/or audio stream is streamed to the second device and during the streaming the user employs the second camera to capture and image and send the image to the second device during the streaming. Such a process may be repeated multiple times so that a plurality of images are captured by the second camera during the video stream of the first camera and the plurality of images are sent to the second device during the stream from the first camera.

In one embodiment, the mixed media content may also be simultaneously sent to a plurality of other devices. In one embodiment, the mixed media content comprises two video streams, one from a first camera from the first device and one from a second camera of the first device with one corresponding audio streams.

The second device may be substantially the same as the first device or may be different. The first device may also be able to edit, filter, or otherwise modify the communication before it is sent. For example, the video portion may be edited, modified, changed, shortened, effects added, etc. via a user interface that provides options to a user. The captured image may also be animated, cropped, filtered, effects added, text added, etc. The device may also offer options to a user for how the mixed media communication will be displayed on another device. For example, the device may offer the user a choice of whether a video is displayed in the foreground while the image is displayed in the background or vice versa, whether the image and video are side by side or whether the image and video are displayed using picture-in-picture techniques.

### Methods and Systems for a Mixed Media Communication from Multimodal Sensors

FIG. 1 depicts an embodiment of device 100. Device 100 is configured to create, send, receive, and/or display a mixed media communication from multimodal sensors. The mixed media communication may comprise any number of combinations of media including audio portions, image portions, video portions, text portions, animations, effects, including a plurality or combinations of any of these items. It should be appreciated that device 100 may be a smart phone, a cell phone, a desktop computer, a laptop, a notebook, a netbook, a hand held device, a personal digital assistant, a television, or similar electronic device capable of participating in a mixed media communication from multimodal sensors across a network.

In one embodiment, device 100 is able to send and receive communications. Such communications may be mixed media communications that are captured using multimodal sensors where the communication is for social communication between users. One example of a mixed media communication is an image with a corresponding audio and video stream that is sent simultaneously in real time from a first device to a second device. Device 100 may be built exclusively for creating, sending and receiving mixed media communications or may be a device that serves other functions as well. For example, device 100 may be a smart phone that employs an operating system. In one embodiment, the present technology may deploy on the smart phone as an application or app. The app may include a user interface and makes use of the hardware features of the device to capture content, create communications, send and receive communications, and display or play back communications. The communication may also be described as a message or messaging.

For clarity and brevity, the discussion will focus on the components and functionality of device 100. However, device 200 of FIG. 2 and device 300 of FIGS. 3A and 3B operate in a similar fashion and have similar capabilities as device 100. In one embodiment, device 200 and device 300 are the same as device 100 and includes the same components as device 100.

Device 100 is depicted as comprising display 110, processor 120, first image capturing device 150, second image capturing device 151, microphone 152, speaker 154, global positioning system 160, transceiver 161, and light sensor 162. It should be appreciated that that device 100 may or may not include all of the depicted components.

Display 110 is configured for displaying images, pictures, text, animations, effects, mixed media communications, user interfaces, etc. Display 110 is further configured for displaying images or video captured by device 100 or for displaying images, pictures, videos or communications captured by another device and received by device 100. In one embodiment, display 110 is a touchscreen and is able to display a user interface with regions that can be pressed or selected by the user to initiate commands.

Transceiver 161 is for transmitting and receiving data related to a communication such as text, speech, audio, video, animations, or the communication itself. Transceiver 161 may operate to send and receive a communication over a network to another device. For example, the network may be a cellar network such as 3G or 4G network. In other embodiments, the network may be a Wi-Fi network, a Bluetooth network, a near field communication, or other network for sending and receiving electromagnetic radio signals. In one embodiment, the network is part of or is in communication with the Internet. A communication may be sent directly from one device to another or may be routed or relayed through other devices or servers. For example, a peer-to-peer network may be employed or a central server that links devices together or identifies devices via contact information.

First image capturing device 150 is an image capturing devices for capturing images, video, or pictures at device 100 such as a digital camera, video camera, or a charge-couple device (CCD). In one embodiment, first image capture device 150 is on a front face of device 100 and is oriented in the same direction as display 110. Thus first image capturing device 150 would be able to capture images or video of a user viewing display 110. It should be appreciated that device 100 may also include an additional camera (e.g., second image capturing device 151) on a back face of device 100 facing opposite first image capturing device 150. Microphone 152 is for capturing audio at device 100. Speaker 154 is for generating an audible signal at device 100 such as the audio stream of a communication from another device. Device 100 may also incorporate a headphone jack used to plug headphones or speakers into device 100 for audible signals. Global positioning system 160 is for determining a location of a device 100.

Device 100 may generate or capture first data 164 and second data 165. First data 164 and second data 165 may be one or more of the following: an image, video, or audio in response to a command from a user. In one embodiment, first data 164 is a video and audio stream captured by first image capturing device 150 with microphone 152 and second data 165 is one or more images captured by second image capturing device 151. Processor 120 is employed to control the components of device 100 and is able to processes first data 164 and second data 165. For example, processor 120 may combine first data 164 and second data 165 such that they are simultaneously transmitted to one or more devices via transceiver 161. Transceiver 161 is able to simultaneously send first data 164 and second data 165 to a second device in real time.

First data 164 and second data 165 may be combined by processor 120 to form a mixed media communication. First data 164 and second data 165 may be displayed simultaneously on a display of the device generating the mixed media communication or a on a display of a second device receiving the mixed media communication.

In one embodiment, the mixed media communication is an image combined with a video stream such that the image and video stream are displayed simultaneously on the same display. The image may be described as a picture or a still frame. For example, the image and video stream may be displayed simultaneously on display 110 while they are being captured such that a user of device 100 may be able to see the video stream and image as they are captured and thus receive feedback. The image and video stream may also be simultaneously displayed on a single display of a second device receiving the image and video stream. An audio stream may also be simultaneously sent with the image and video stream in real time.

First data 164 and second data 165 may be displayed using a variety of schemes. In one embodiment, first data 164 and second data 165 are displayed side by side in a first region and a second region of the display. The first and second regions may or may not be equal in size. In one embodiment, the first and second regions overlap one another and one may be described as the foreground and the other the background. In one embodiment, first data 164 and second data 165 are displayed using a picture-in-picture technique. In one embodiment, first data 164 is segmented and placed in a background relative to second data 165 at the display.

In one embodiment, the position of first data 164 and second data 165 on the display may be swapped. This is true for all embodiments including a side by side display, a picture-in-picture display, and an overlapping background-foreground display. The scheme used to display the mixed media communication may be controlled by default settings or may be customizable by a user. In one embodiment, the display scheme may be changed during the streaming of the mixed media communication. For example, the mixed media communication may begin with first data 164 side by side with second data 165 but then midway through the streaming it may be switched to a picture-in-picture scheme. It should be appreciated that the display schemes and positions may swapped and interchanged in a variety of ways and may be swapped or interchanged any number of times during a transmission or streaming of the mixed media communication.

In one embodiment, the device creating and sending the mixed media communication has control over the display scheme and the swapping or interchanging. In one embodiment, the device receiving the mixed media communication has control over the display scheme and the swapping or interchanging. In one embodiment, any device involved in the communication has control over the display scheme. Such control may be performed by processor 120 in response to user commands received at a user interface of device 100.

In one embodiment, both the first and second device simultaneously generating, receiving, and transmitting a mixed media communication. For example, both devices may be capturing and generating images and/or video and transmitting that data to the other device while simultaneously receiving data from the other device and displaying it.

In one embodiment, the back camera or second image capturing device 151 employs light sensor 162 to compensate the front camera lightness. For example, the front camera may capture video of a user's face which has more lightness than an image captured by the back camera.

Device 100 is also able to participate in video conference with another device such as a handheld device or a computer. During a video conference, first image capturing device 150 captures video at device 100. For example, first image capturing device 150 captures video of a user or other object. Microphone 152 may simultaneously captures audio signals corresponding to the captured video signal at device 100. Similarly, a second device may also be capturing audio and video. The two devices may then exchange the video and audio. Device 100, in a video conference, may be able to display a real time or live video stream captured by a second device and simultaneously display video captured by device 100 in two different regions of display 110. The video conference may also include a plurality of devices. The audio and video from the plurality of devices may be displayed via device 100. Device 100 may be capable of recording the video conference which may include audio from and video from multiple devices.

In one embodiment, device 100 is capable of capturing a screen shot of the video conference or a video stream. The screen shot may also be described as a snapshot or a still frame of the video. The screen shot may include images from multiple video source or video from only one source. The screen shot may be selected by a user or may be randomly selected by processor 120.

In one embodiment, the captured content for the mixed media communication may include location data of where the content was captured. The location data may be generated via global positioning system 160.

Processor 120 may be able to create a mixed media communication with a plurality of images, audio portions, videos, animations, or any combination thereof. In one embodiment, the content of the mixed media communication need not be generated or captured by device 100. For example, device 100 may receive an image or other content from another device or may download an image from the Internet which is then employed by processor 120 to create the mixed media communication.

The audio stream need not be voice but can be music or other audible sounds. In one embodiment, the audio stream relates to the image, video or other content of the mixed media communication. Specifically, the audio stream may be a verbal description of what is in an image or video. For example, the user may be on vacation and capture an image of an important landmark and then device 100 will capture an audio stream from the user describing the landmark. In one embodiment, the audio is not a message and does not relate to the other content of the mixed media communication.

It should be appreciated that device 100 may capture audio and images in any number of sequences. In one embodiment, the audio and video are first captured and the image is later captured during a streaming of the mixed media communication. In one embodiment, the mixed media communication may be a continuous stream of video and/or audio that is captured using first image capturing device 150 and a plurality of images are captured by second image capturing device 151 in sequence and sent one at a time to the second device as part of the mixed media communication. In one embodiment, device 100 captures an image, video, and audio simultaneously using a plurality of cameras.

Device 100 may be capable of receiving a mixed media communication or stream from another device. In one embodiment, device 100 automatically displays the mixed media communication upon receiving it. In one embodiment, when device 100 receives a mixed media communication it may alert a user of the mixed media communication using any number of standard alerts associated with a device receiving a message or communication. The user may then command device 100 to open or access the mixed media communication.

In generating a mixed media communication, device 100 may also be capable of editing or filtering content in a mixed media communication. Images and videos may be cropped or brightness and color controlled or other standard editing techniques employed. Videos may be shortened. Animations and other effects may be added to the content of the mixed media communication. Device 100 may employ a user interface to receive command regarding such editing, filtering, altering, changing or other effects. Text and other effects may be superimposed over the top of a video or image. In one embodiment, a pinpoint may be added to identify an object in the image. For example, the pinpoint may be in the shape of an arrow or other indicator that points to an object such as a tree or a portion. The identified object in the image may also be a region of the image. In one embodiment, the image may be altered to such that a region of the image is magnified. This may be described as zooming in on a portion of the image. The magnified region may be the only portion of the image that is displayed in the mixed media communication.

In one embodiment, a mixed media communication may be sent to a website that hosts videos, pictures, or other content such that other users may access the content on demand or the website may automatically forward the content to designated users.

With reference now to FIG. 2, a block diagram of an example environment in accordance with embodiments of the present technology. FIG. 2 depicts device 200 with microphone 225, image capturing device 230, and region 210. FIG. 2 also depicts object 215 and user 205. Device 200 may be employed to capture image 220 of object 215. As can be seen, image 220 is a picture of object 215 which is depicted in FIG. 2 to be a structure or landmark such as a building. Device 200 may also record a video of user 205 via image capturing device 230 which may be referred to as a front camera. Video of user 205 may be displayed in region 210.

Region 210 may also be used to display other controls such as editing controls or controls for selecting a contact to send the mixed media communication to. In one embodiment, user 205 may be able to see image 220 on the display of device 200 while the video and audio are being captured. It should be appreciated that image 220 may be captured either before or during the capture of video via image capturing device 230. Image 220 and the video are then simultaneously sent to another device.

With reference now to FIG. 3A, a block diagram of an example environment in accordance with embodiments of the present technology. FIG. 3A depicts a side view of device 300 comprising front camera 305, back camera 310 and microphone 312. FIG. 3A also depicts user 314 and object 320. In one embodiment, back camera 310 is used to capture a picture of object 320, front camera is used to capture a video of user 314 and microphone 312 is used to capture audio. The picture, video and audio are employed to create a mixed media communication. The picture, video and audio can be captured simultaneously if device 300 has more than one camera. Alternatively, the picture, video and audio may be captured in any sequence or order and may or may not be captured by device 300 and its components.

In one example, device 300 captures a picture of object 320 and captures a video with an audio or voice track of user 314 explaining or providing information regarding object 320. For example, user 314 may explain why object 320 is significant or how user 314 traveled to object 314 or any other type of information. The picture, audio and video may then be employed to create a mixed media communication.

With reference now to FIG. 3B, a block diagram of an example environment in accordance with embodiments of the present technology. FIG. 3B depicts a front view of device 300 receiving and displaying or playing the mixed media communication created using the picture, audio and video captured as described in FIG. 3A. Image 325 is a picture of object 320 and video 330 is a video of user 314. The mixed media communication is displayed such that image 325 is displayed in a continuous static fashion while video 330 is displayed as a video while at the same time the audio message is played back. Thus the mixed media communication may display a picture and a video of the user explaining or providing information regarding the picture. The video may be helpful to show facial features, body language, or gestures of the user which aid in the communication. Video 330 and image 325 may be displayed in separate regions of the display of device 300 using split screen techniques or picture-in-picture techniques. However, video 330 and image 325 may also be displayed in the same region where they overlap one another. For example, image 325 may comprise the whole of the display and be in the background while video 330 is in the foreground on top of image 325. Conversely, image 325 may be in the foreground with video 330 in the background.

It should be noted that the various embodiments described herein can also be used in combination with one another. That is one described embodiment can be used in combination with one or more other described embodiments.

### Operations of a Mixed Media Communication from Multimodal Sensors

FIG. 4 is a flowchart illustrating process 400 for a mixed media communication from multimodal sensors in accordance with one embodiment of the present technology. In one embodiment, process 400 is a computer implemented method that is carried out by processors and electrical components under the control of computer usable and computer executable instructions. The computer usable and computer executable instructions reside, for example, in data storage features such as computer usable volatile and non-volatile memory and may be non-transitory. However, the computer usable and computer executable instructions may reside in any type of computer usable storage medium. In one embodiment, process 400 is performed by the components of FIGS. 1, 2, 3A, and/or 3B.

At 402, a first data is captured at a first image capturing device associated with a first communication device. In one embodiment, the first data is a video captured by a front camera associated with the first communication device.

At 404, a second data is captured at a second image capturing device associated with the first communication device. In one embodiment, the second data is an image or still frame picture captured by a back camera associated with the first communication device. The first and second data may be captured simultaneously.

At 406, the first data and the second data are simultaneously sent to a second communication device to be displayed simultaneously on a display of the second communication device. This may be accomplished using a transceiver of the first communication device. The first and second data may be described as a mixed media communication and may be displayed using a variety of display schemes. In one embodiment, the first and second data are displayed in real time as they are received at the second communication device. In one embodiment, the display scheme for the first and second data may be changed, swapped, or interchanged one or more times during the sending of the communication. This may be controlled by either the first or second communication device.

FIG. 5 is a flowchart illustrating process 500 for a mixed media communication from multimodal sensors in accordance with one embodiment of the present technology. In one embodiment, process 500 is a computer implemented method that is carried out by processors and electrical components under the control of computer usable and computer executable instructions. The computer usable and computer executable instructions reside, for example, in data storage features such as computer usable volatile and non-volatile memory and may be non-transitory. However, the computer usable and computer executable instructions may reside in any type of computer usable storage medium. In one embodiment, process 500 is performed by the components of FIGS. 1, 2, 3A, and/or 3B.

At 502, a first data is received at second communication device captured by a first image capturing device associated with a first communication device. In one embodiment, the first data is a video captured by a front camera associated with the first communication device.

At 504, a second data is received at second communication device captured by a second image capturing device associated with a first communication device, wherein the first data and the second data are received simultaneously. In one embodiment, the second data is an image or still frame picture captured by a back camera associated with the first communication device. The first and second data may be captured simultaneously.

At 506, the first data and the second data are simultaneously displayed on a single display of the second communication device. This may be accomplished using a transceiver of the first communication device. The first and second data may be described as a mixed media communication and may be displayed using a variety of display schemes. In one embodiment, the first and second data are displayed in real time as they are received at the second communication device. In one embodiment, the display scheme for the first and second data may be changed, swapped, or interchanged one or more times during the sending of the communication. This may be controlled by either the first or second communication device.

Various embodiments are thus described. While particular embodiments have been described, it should be appreciated that the embodiments should not be construed as limited by such description, but rather construed according to the following claims.

### Example Computer System Environment

Portions of the present technology are composed of computer-readable and computer-executable instructions that reside, for example, in computer-usable media of a computer system or other user device such as a smart phone used for mixed media communication. Described below is an example computer system or components that may be used for or in conjunction with aspects of the present technology.

It is appreciated that that the present technology can operate on or within a number of different computer systems including general purpose networked computer systems, embedded computer systems, cloud-based computers, routers, switches, server devices, user devices, various intermediate devices/artifacts, stand-alone computer systems, mobile phones, personal data assistants, televisions and the like. The computer system is well adapted to having peripheral computer readable media such as, for example, a floppy disk, a compact disc, and the like coupled thereto.

The computer system includes an address/data bus for communicating information, and a processor coupled to bus for processing information and instructions. The computer system is also well suited to a multi-processor or single processor environment and also includes data storage features such as a computer usable volatile memory, e.g. random access memory (RAM), coupled to bus for storing information and instructions for processor(s).

The computer system may also include computer usable non-volatile memory, e.g. read only memory (ROM), as well as input devices such as an alpha-numeric input device, a mouse, or other commonly used input devices. The computer system may also include a display such as liquid crystal device, cathode ray tube, plasma display, and other output components such as a printer or other common output devices.

The computer system may also include one or more signal generating and receiving device(s) coupled with a bus for enabling the system to interface with other electronic devices and computer systems. Signal generating and receiving device(s) of the present embodiment may include wired serial adaptors, modems, and network adaptors, wireless modems, and wireless network adaptors, and other such communication technology. The signal generating and receiving device(s) may work in conjunction with one or more communication interface(s) for coupling information to and/or from the computer system. A communication interface may include a serial port, parallel port, Universal Serial Bus (USB), Ethernet port, antenna, or other input/output interface. A communication interface may physically, electrically, optically, or wirelessly (e.g. via radio frequency) couple the computer system with another device, such as a cellular telephone, radio, a handheld device, a smartphone, or computer system.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for a mixed media communication from multimodal sensors, said method comprising:
capturing a first data at a first image capturing device associated with a first communication device;
capturing a second data at a second image capturing device associated with said first communication device; and
simultaneously sending said first data and said second data to a second communication device to be displayed simultaneously on a display of said second communication device.

2. The method recited in claim 1 wherein said first communication device controls how said first data and said second data are arraigned on said display of said second communication device.

3. The method recited in claim 1 wherein said second communication device controls how said first data and said second data are arraigned on said display of said second communication device.

4. The method as recited in claim 1 wherein said first data is a video stream comprising video and audio content and said second data is an image.

5. The method as recited in claim 1 wherein said first data is a video stream comprising video and audio content and said second data is a plurality of images.

6. The method as recited in claim 1 wherein said first data is displayed in a first region of said display of said second communication device and wherein said second data is displayed in a second region of said display of said second communication device, said method further comprising:
swapping said first data in said first region is swapped with said second data in said second region.

7. The method as recited in claim 1 wherein said first data is displayed side by side with said second data at said display of said second communication device.

8. The method as recited in claim 1 wherein said first data is displayed as a picture-in-picture of said second data at said display of said second communication device.

9. The method as recited in claim 1 wherein said first data is segmented and placed in a background relative to said second data at said display of said second communication device.

10. The method as recited in claim 1 wherein said second image capturing device employs a light sensor for said capturing to compensate for lightness in said first data captured by said first capturing device.

11. The method as recited in claim 1 wherein said first image capturing device faces in an opposite direction than said second image capturing device.

12. A method for a mixed media communication from multimodal sensors, said method comprising:
receiving a first data at second communication device captured by a first image capturing device associated with a first communication device;
receiving a second data at second communication device captured by a second image capturing device associated with a first communication device, wherein said first data and said second data are received simultaneously; and
displaying said first data and said second data simultaneously on a single display of said second communication device.

13. The method recited in claim 12 wherein said first communication device controls how said first data and said second data are arraigned on said display of said second communication device.

14. The method recited in claim 12 wherein said second communication device controls how said first data and said second data are arraigned on said display of said second communication device.

15. The method as recited in claim 12 wherein said first data is a video stream comprising video and audio content and said second data is an image.

16. The method as recited in claim 12 wherein said first data is a video stream comprising video and audio content and said second data is a plurality of images.

17. The method as recited in claim 12 wherein said first data is displayed in a first region of said display of said second communication device and wherein said second data is displayed in a second region of said display of said second communication device, said method further comprising:
swapping said first data in said first region is swapped with said second data in said second region.

18. The method as recited in claim 12 wherein said first data is displayed side by side with said second data at said display of said second communication device.

19. The method as recited in claim 12 wherein said first data is displayed as a picture-in-picture of said second data at said display of said second communication device.

20. The method as recited in claim 12 wherein said first data is segmented and placed in a background relative to said second data at said display of said second communication device.

21. The method as recited in claim 12 wherein said second image capturing device employs a light sensor for said capturing to compensate for lightness in said first data captured by said first capturing device.

22. The method as recited in claim 12 wherein said first image capturing device faces in an opposite direction than said second image capturing device.

23. A computer-usable storage medium having instructions embodied therein that when executed cause a computer system to perform a method for a mixed media communication from multimodal sensors, said method comprising:
capturing a first data at a first image capturing device associated with a first communication device;
capturing a second data at a second image capturing device associated with said first communication device; and
simultaneously sending said first data and said second data to a second communication device to be displayed simultaneously on a display of said second communication device.

24. A device for a mixed media communication from multimodal sensors, said device comprising:
a first image capturing device for capturing a first data, wherein said first image capturing device is oriented a same direction as a display of said device;
a microphone for capturing audio content related to said first data;
a second image capturing device for capturing a second data, wherein said second image capturing device is oriented in an opposite direction of said first image capturing device; and
a transmitter for simultaneously sending said first data and said second data to a second communication device to be displayed simultaneously on a display of said second communication device.

25. The device as recited in claim 24 wherein said first data is a video stream comprising video and audio content and said second data is an image.

26. The device as recited in claim 24 wherein said first data is a video stream comprising video and audio content and said second data is a plurality of images.
